(19) United States
(12) Patent Application Publication
(10) Pub. No.: US 2026/0024337 A1
(43) Pub. Date: Jan. 22, 2026

(54) GENERATING MASK-GUIDED INSTANCE MATTES FOR DIGITAL IMAGES AND DIGITAL VIDEOS USING A SINGLE-PASS NEURAL NETWORK

(71) Applicant: Adobe Inc., San Jose, CA (US)

(72) Inventors: Joon-Young Lee, Miliptas, CA (US); Chuong Huynh, Hyattsville, MD (US); Seoung Wug Oh, San Jose, CA (US); Markus Woodson, Santa Clara, CA (US)

(21) Appl. No.: 18/779,880

(22) Filed: Jul. 22, 2024

(51) Int. Cl. G06V 20/40; G06V 10/26; G06V 10/77; G06V 10/82

(52) U.S. Cl. CPC G06V 20/49; G06V 10/26; G06V 10/7715; G06V 10/82; G06V 20/46

(57) ABSTRACT

The present disclosure relates to systems, methods, and non-transitory computer-readable media that generate mattes for objects portrayed in digital images and/or digital videos. For example, in some embodiments, the disclosed systems receive a digital image portraying one or more objects. The disclosed systems generate, via an instance matting neural network and using the digital image and a guidance mask for each object from the one or more objects, a coarse matte prediction for each object. The disclosed systems further generate, using an instance guidance model of the instance matting neural network, a refined matte prediction for each object from the coarse matte prediction for each object. The disclosed systems provide, for display, a modified digital image generated from the refined matte prediction for each object.

### BACKGROUND

Recent years have seen significant advancement in hardware and software platforms for editing digital images and digital videos. Indeed, as the use of digital images and digital videos have become increasingly ubiquitous, systems have developed to facilitate the manipulation of the content within such images or videos. To illustrate, many systems offer tools for generating segmentation masks or mattes for objects portrayed within an image or video. Some systems use the masks or mattes to modify the content within an image or video, such as by modifying a portrayed object or the area surrounding a portrayed object.

### SUMMARY

One or more embodiments described herein provide benefits and/or solve one or more problems in the art with systems, methods, and non-transitory computer-readable media that use a neural network to efficiently generate instance mattes for objects portrayed within a digital image or digital video. For instance, in one or more embodiments, a system uses the neural network to generate refined mattes for multiple instances portrayed in a digital image or video frame in a single pass. To illustrate, in some cases, the system uses the neural network to perform multi-instance prediction at the coarse level and progressively refine the predictions at multiple scales. In some embodiments, the neural network implements mask guidance, transformer attention, and/or sparse convolutions in its predictions and/or refinement processes. Additionally, in some instances, the neural network includes an instance guidance module that transforms image- or frame-generic information into instance-specific features. In this manner, the system efficiently produces refined instance mattes usable for modifying a corresponding image or video frame.

Additional features and advantages of one or more embodiments of the present disclosure are outlined in the description which follows, and in part will be obvious from the description, or are learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an instance matting system operates in accordance with one or more embodiments;

FIG. 2 illustrates the instance matting system generating and using mattes in accordance with one or more embodiments;

FIGS. 3A-3B illustrate an instance matting neural network used by the instance matting system to generate mattes in accordance with one or more embodiments;

FIGS. 4A-4D illustrate various components incorporated within an instance matting neural network used by the instance matting system in accordance with one or more embodiments;

FIG. 5 illustrates graphs reflecting experimental results regarding the efficiency of the instance matting system in generating mattes for objects portrayed in a digital image or video frame in accordance with one or more embodiments;

FIG. 6 illustrates a table reflecting experimental results regarding the accuracy with which the instance matting system generates mattes for objects portrayed in digital images in accordance with one or more embodiments;

FIG. 7 illustrates a table reflecting experimental results regarding the accuracy with which the instance matting system generates mattes for objects portrayed in digital videos in accordance with one or more embodiments;

FIG. 8 illustrates an example schematic diagram of an instance matting system in accordance with one or more embodiments;

FIG. 9 illustrates a flowchart of a series of acts for generating refined matte predictions for objects portrayed in a digital image in accordance with one or more embodiments; and

FIG. 10 illustrates a block diagram of an exemplary computing device in accordance with one or more embodiments.

### DETAILED DESCRIPTION

One or more embodiments described herein include an instance matting system that efficiently generates mattes for object instances portrayed in a digital image or digital video using an efficient mask-guided neural network. To illustrate, in one or more embodiments, the instance matting system uses a neural network to generate mattes from an image (or video frame) and binary masks corresponding to objects portrayed in the image (or video frame). In some cases, the neural network generates coarse matte predictions and progressively refines the predictions at multiple scales to produce the mattes. Additionally, in some embodiments, the neural network implements transformer attention, sparse convolutions, and/or an instance guidance module as part of the initial prediction and/or refinement processes. In certain embodiments, to create consistency among mattes across video frames, the neural network implements temporal aggregation at the feature level and/or matte level.

To illustrate, in one or more embodiments, the instance matting system receives a digital image portraying one or more objects. The instance matting system generates, via an instance matting neural network and using the digital image and a guidance mask for each object from the one or more objects, a coarse matte prediction for each object. Additionally, the instance matting system generates, using an instance guidance model of the instance matting neural network, a refined matte prediction for each object from the coarse matte prediction for each object. The instance matting system provides, for display, a modified digital image generated from the refined matte prediction for each object.

As just indicated, in one or more embodiments, the instance matting system generates refined mattes for objects portrayed in digital images. In particular, in some embodiments, a digital image portrays one or more objects, and the instance matting system generates a refined matte for each portrayed object. Similarly, in some cases, the instance matting system generates refined mattes for objects portrayed in digital videos, such as by generating a refined matte for each object portrayed in a digital video. In some implementations, the instance matting system generates multiple refined mattes for an object portrayed in a digital video, such as by generating a refined matte for each video frame that portrays the object.

Additionally, as mentioned, in certain embodiments, the instance matting system uses guidance masks in generating refined mattes. For instance, in some cases, the instance matting system generates a refined matte for an object using the digital image (or video frame) portraying the object and a guidance mask for the object. In some instances, where the object is portrayed in a video frame, the instance matting system uses the guidance mask for the object that corresponds to the video frame.

As further mentioned, in one or more embodiments, the instance matting system uses an instance matting neural network to generate the refined mattes. For instance, in some embodiments, the instance matting system uses the instance matting neural network to generate a refined matte for an object portrayed in a digital image (or video frame) by generating a coarse matte prediction for the object and progressively refining the coarse matte prediction. In some cases, the neural network uses transformer attention, sparse convolutions, and/or an instance guidance model in generating and/or refining the coarse matte prediction.

In some embodiments, the instance matting system uses feature-level fusion when generating mattes for objects portrayed in a digital video. For instance, in some cases, the instance matting system uses the instance matting neural network to fuse features determined for a particular video frame with features determined for one or more adjacent video frames (e.g., a preceding video frame and/or a subsequent video frame).

In certain cases, the instance matting system uses matte-level fusion when generating mattes for objects portrayed in a digital video. For example, in some embodiments, the instance matting system uses the instance matting neural network to fuse a refined matte of an object generated for a video frame with a refined matte of the object generated for one or more adjacent video frames (e.g., a preceding video frame and/or a subsequent video frame). Thus, in some implementations, the instance matting system generates a video frame matte of the object for the video frame.

In one or more embodiments, the instance matting system modifies a digital image using the refined matte generated for each object portrayed therein. Similarly, in some embodiments, the instance matting system modifies a digital video using the refined mattes (or video frame mattes) generated for each object portrayed therein. In particular, in some cases, the instance matting system modifies a video frame of the digital video using the refined matte (or video frame matte) generated for each object portrayed therein.

The instance matting system provides advantages over conventional systems. Indeed, conventional object matting systems suffer from several technological shortcomings that result in in inflexible, inefficient, and inaccurate operation. To illustrate, many conventional systems are inflexible in that they are limited in their application. For instance, some conventional systems fail to provide instance awareness, limiting their application to single-object scenarios. Other systems may work well on images—including images that portray multiple objects—but fail to extend their application to digital videos.

Additionally, many conventional object matting systems fail to operate efficiently. For example, many conventional systems operate on objects portrayed in an image or video separately. In particular, where an image or video portrays multiple objects, many systems generate a matte for each object separately. Thus, systems employing a neural network or some other model typically require multiple passes through the model to produce a matte for each object. As a result, the computing resources consumed by such systems (e.g., GPU memory or time) increases with the complexity of the image or video frame being processed (e.g., the number of objects portrayed within the image or video frame).

Further, conventional object matting systems often experience problems with accuracy. In particular, many conventional systems fail to generate mattes that accurately correspond to (e.g., represent) the objects for which they are generated. This is particularly true for many systems that generate mattes for objects portrayed in digital videos. For instance, conventional systems often fail to provide temporal consistency, which causes artefacts that arise in one video frame to persist across subsequent video frames. While some systems attempt to improve temporal consistency via aggregation at the feature level, alpha matte values tend to be very sensitive and susceptible to error; thus, these systems often fail to solve the temporal consistency problem.

One or more embodiments of the instance matting system operate with improved flexibility when compared to conventional systems. For instance, one or more embodiments of the instance matting system generate mattes in multi-instance scenarios. Further, certain embodiments of the instance matting system generate mattes for objects portrayed within digital videos. Indeed, in some cases, the instance matting system offers both instance awareness and video compatibility to generate mattes for multiple objects portrayed within a digital video.

Additionally, one or more embodiments of the instance matting system operate with improved efficiency when compared to conventional systems. For instance, embodiments of the instance matting system use an instance matting neural network to generate refined mattes (or video frame mattes) for objects portrayed within a digital image or video frame-even where multiple objects are portrayed—using a single forward pass. For instance, neural network features incorporated by various embodiments of the instance matting systems, such as transformer attention, sparse convolutions, and an instanced guidance model allow for the single pass generation of mattes. Further, many neural network features incorporated by embodiments of the instance matting system enable a more stable algorithmic complexity when compared to conventional systems. To illustrate, some embodiments of the instance matting system incorporate multi-instance prediction at the coarse level by generating a coarse matte prediction for each object portrayed in a digital image or video frame. While subsequently refined, incorporating the coarse-level prediction reduces the complexity of generating the output mattes. Further, by incorporating sparse convolutions, embodiments of the instance matting system save further on computational costs at inference time as these embodiments focus the refinement process on those pixels that benefit most. Thus, embodiments of the instance matting system stabilize—and in some cases reduce—the demand on computing resources regardless of the number of instances for which mattes are being generated.

Further, one or more embodiments of the instance matting system operate with improved accuracy when compared to conventional systems. In particular, embodiments of the instance matting system produce mattes that more accurately represent the objects for which they were generated. For instance, embodiments of the instance matting system generate mattes for objects portrayed in digital videos. with improved temporal consistency. Indeed, embodiments that implement aggregation at both the feature level and the matte level improve the consistency of representation across frames. Many embodiments implement backward and forward aggregation, ensuring that artefacts or other errors present in a preceding video frame are checked against the subsequent video frame.

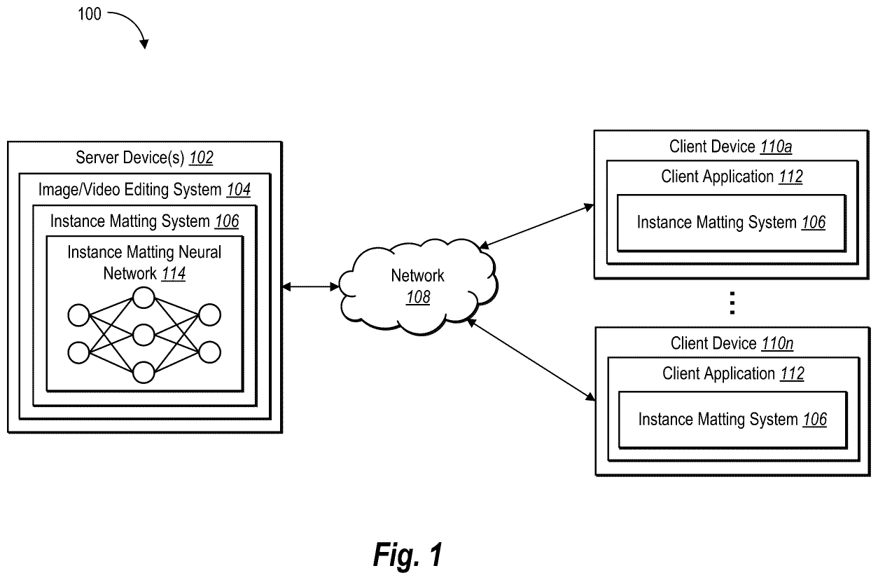

Additional detail regarding the instance matting system will now be provided with reference to the figures. For example, FIG. 1 illustrates a schematic diagram of an exemplary system 100 in which an instance matting system 106 operates. As illustrated in FIG. 1, the system 100 includes a server device(s) 102, a network 108, and client devices 110a-110n.

Although the system 100 of FIG. 1 is depicted as having a particular number of components, the system 100 is capable of having any number of additional or alternative components (e.g., any number of server devices, client devices, or other components in communication with the instance matting system 106 via the network 108). Similarly, although FIG. 1 illustrates a particular arrangement of the server device(s) 102, the network 108, and the client devices 110a-110n, various additional arrangements are possible.

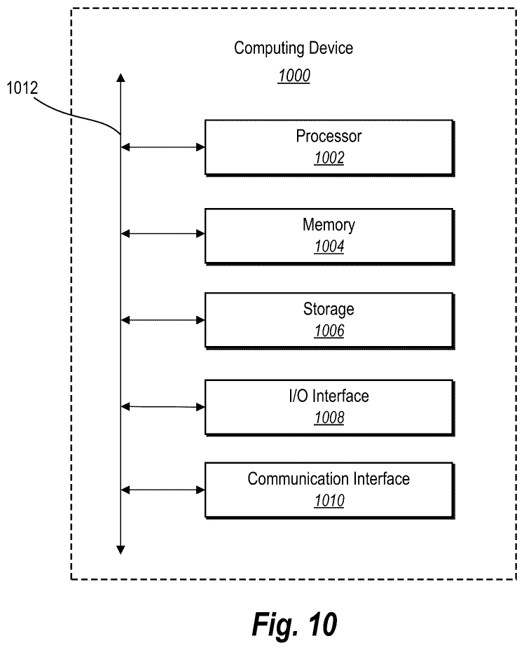

The server device(s) 102, the network 108, and the client devices 110a-110n are communicatively coupled with each other either directly or indirectly (e.g., through the network 108 discussed in greater detail below in relation to FIG. 10). Moreover, the server device(s) 102 and the client devices 110a-110n include one or more of a variety of computing devices (including one or more computing devices as discussed in greater detail with relation to FIG. 10).

As mentioned above, the system 100 includes the server device(s) 102. In one or more embodiments, the server device(s) 102 generates, stores, receives, and/or transmits data, including digital images, digital videos, mattes, modified digital images, and/or modified digital videos. In one or more embodiments, the server device(s) 102 comprises one or more data server devices. In some implementations, the server device(s) 102 comprises one or more communication server devices or one or more web-hosting server devices.

In one or more embodiments, the image/video editing system 104 provides functionality by which a client device (e.g., a user of one of the client devices 110a-110n) generates, edits, manages, and/or stores digital images or digital videos. For example, in some instances, a client device sends a digital image or a digital video to the image/video editing system 104 hosted on the server device(s) 102 via the network 108. The image/video editing system 104 then provides many options that are usable by the client device to edit the digital image or digital video, store the digital image or digital video, and subsequently search for, access, and view the digital image or digital video. For instance, in some cases, the image/video editing system 104 provides one or more options that are usable by the client device to modify a digital image or digital video using mattes generated for objects portrayed therein.

In one or more embodiments, the client devices 110a-110n include computing devices that are capable of accessing, modifying, and/or storing digital images or digital videos, including modified digital images or modified digital videos. For example, in some embodiments, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that are capable of accessing, modifying, and/or storing digital images or digital videos, including modified digital images or modified digital videos. For example, in some embodiments, the client application 112 includes a software application installed on the client devices 110a-110n. Additionally, or alternatively, the client application 112 includes a web browser or other application that accesses a software application hosted on the server device(s) 102 (and supported by the image/video editing system 104).

To provide an example implementation, in some embodiments, the instance matting system 106 on the server device(s) 102 supports the instance matting system 106 on the client device 110n. For instance, in some cases, the instance matting system 106 on the server device(s) 102 generates or learns parameters for the instance matting neural network 114. The instance matting system 106 then, via the server device(s) 102, provides the instance matting neural network 114 to the client device 110n. In other words, the client device 110n obtains (e.g., downloads) the instance matting neural network 114 (e.g., with any learned parameters) from the server device(s) 102. Once downloaded, the instance matting system 106 on the client device 110n utilizes the instance matting neural network 114 to generate mattes for objects portrayed in a digital image or digital video and modify the digital image or digital video using the mattes.

In alternative implementations, the instance matting system 106 includes a web hosting application that allows the client device 110n to interact with content and services hosted on the server device(s) 102. To illustrate, in one or more implementations, the client device 110n accesses a software application supported by the server device(s) 102. The client device 110n provides input to the server device(s) 102, such as a digital image or digital video. In response, the instance matting system 106 on the server device(s) 102 generates mattes for objects portrayed in the digital image or digital video. The server device(s) 102 then provides the mattes and/or the digital image or digital video as modified using the mattes to the client device 110n.

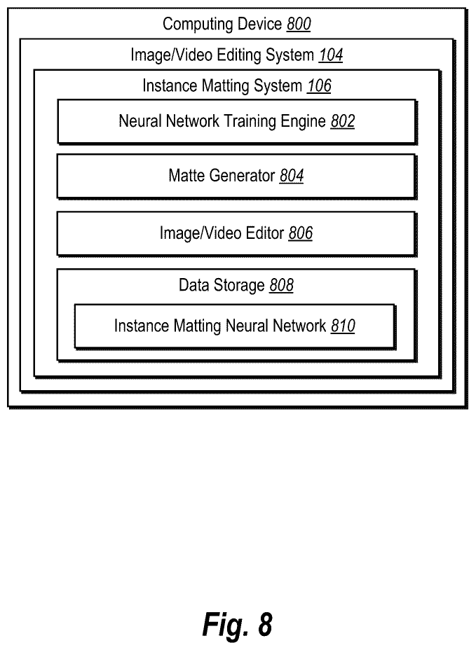

Indeed, the instance matting system 106 is able to be implemented in whole, or in part, by the individual elements of the system 100. Indeed, although FIG. 1 illustrates the instance matting system 106 being implemented with regard to the server device(s) 102, different components of the instance matting system 106 are able to be implemented by a variety of devices within the system 100. For example, one or more (or all) components of the instance matting system 106 are implemented by a different computing device (e.g., one of the client devices 110a-110n) or a separate server device from the server device(s) 102 hosting the image/video editing system 104. Indeed, as shown in FIG. 1, the client devices 110a-110n include the instance matting system 106. Example components of the instance matting system 106 will be described below with regard to FIG. 8.

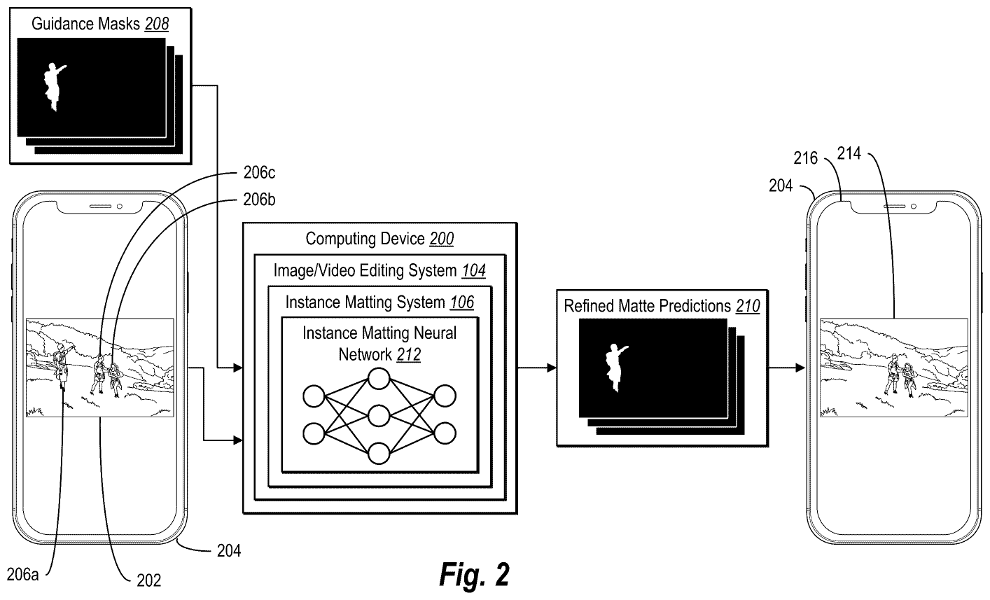

As mentioned, in one or more embodiments, the instance matting system 106 generates mattes for objects portrayed within a digital image or a digital video. Further, in some embodiments, the instance matting system 106 uses the mattes to modify the digital image or digital video. FIG. 2 illustrates the instance matting system 106 generating and using mattes in accordance with one or more embodiments.

In one or more embodiments, a matte includes a set of data having values that distinguish between an object portrayed within a digital image or video frame and other portions of the digital image or video frame based on transparency levels of the pixels contained in the digital image or video frame. For instance, in some cases, a matte includes a grayscale image or alpha channel that defines the transparency level of the pixels contained in a digital image or video frame. To illustrate, in some cases, a matte includes a grayscale image or alpha channel having values that fall within a range 0 to n, where a value of 0 indicates that the corresponding pixel is completely transparent, a value of n indicates that the corresponding pixel is completely opaque, and values in between represent various levels of transparency. In some implementations, the instance matting system 106 determines transparency with respect to the foreground element (e.g., the object) under consideration.

As shown in FIG. 2, the instance matting system 106 (operating on a computing device 200) receives a digital image 202 from a client device 204. Indeed, in some cases, the instance matting system 106 receives the digital image 202 from a computing device (e.g., the client device 204) that is external to the computing device (e.g., the computing device 200) upon which the instance matting system 106 operates. In some embodiments, however, the instance matting system 106 receives the digital image 202 from another source within the computing device upon which the instance matting system 106 operates. For instance, in some cases, the instance matting system 106 retrieves or receives the digital image 202 from an internal storage of the computing device 200 or from another system operating on the computing device 200.

As illustrated in FIG. 2, the digital image 202 portrays objects 206a-206c. In one or more embodiments, an object includes a distinct visual component portrayed in a digital image. In particular, in some embodiments, an object includes a distinct visual element that is identifiable separately from other visual elements portrayed in a digital image. In many instances, an object includes a group of pixels that, together, portray the distinct visual element separately from the portrayal of other pixels. In some cases, an object refers to a visual representation of a subject, concept, or sub-concept in an image. In particular, in certain cases, an object refers to a set of pixels in an image that combine to form a visual depiction of an item, article, partial item, component, or element. In some cases, an object is identifiable via various levels of abstraction. In other words, in some instances, an object includes separate object components that are identifiable individually or as part of an aggregate. To illustrate, in some embodiments, an object includes a semantic area (e.g., the sky, the ground, water, etc.). In some embodiments, an object comprises an instance of an identifiable thing (e.g., a person, an animal, a building, a car, or a cloud, clothing, or some other accessory). In one or more embodiments, an object includes sub-objects, parts, or portions. For example, in some embodiments, a person's face, hair, or leg is an object that is part of another object (e.g., the person's body). In still further implementations, a shadow or a reflection comprises part of an object. As another example, in some instances, a shirt is an object that is part of another object (e.g., a person).

Each of the objects 206a-206c shown in FIG. 2 includes a human. Indeed, one or more embodiments of the instance matting system 106 generate mattes for humans portrayed in a digital image. While the instance matting system 106 is not limited to processing digital images portraying humans (i.e., embodiments of the instance matting system 106 generate mattes for various objects), generating mattes for humans or other similar objects (e.g., animals) is a particular challenge as the task often involves dealing with complex boundaries (e.g., boundaries associated with hair).

As further illustrated, the digital image 202 portrays a particular number of objects. It should be understood, however, that embodiments of the instance matting system 106 generates mattes for various numbers of objects portrayed in a digital image. Indeed, generally speaking, embodiments of the instance matting system 106 generate one or more mattes for one or more objects portrayed in a digital image.

It should be further understood that, while FIG. 2 portrays the instance matting system 106 generating mattes for the digital image 202, one or more embodiments of the instance matting system 106 generate mattes for digital videos. In some cases, the instance matting system 106 generates mattes for a digital video by generating mattes for one or more video frames of the digital video (e.g., generating one or more mattes for one or more objects portrayed in a video frame). In certain embodiments, the instance matting system 106 generates mattes for a video frame in the same manner as mattes are generated for a digital image. In some implementations, however, the instance matting system 106 incorporates alternative or additional steps when generating mattes for a video frame.

As shown in FIG. 2, the instance matting system 106 further receives guidance masks 208 corresponding to the objects 206a-206c portrayed in the digital image 202. In one or more embodiments, a guidance mask includes a mask that guides the generation of a matte. In particular, in some cases, a guidance mask includes a mask that corresponds to an object portrayed within a digital image or video frame and guides the generation of a matte for the object. In some implementations, a mask includes a map of a digital image or video frame that has an indication for each pixel of whether the pixel corresponds to part of an object (or other semantic area) or not. In some implementations, the indication includes a binary indication (e.g., a “1” for pixels belonging to the object and a “0” for pixels not belonging to the object). In alternative implementations, the indication includes a probability (e.g., a number between 1 and 0) that indicates the likelihood that a pixel belongs to an object. To illustrate, in some cases, the closer the value is to 1, the more likely the pixel belongs to an object and vice versa.

In one or more embodiments, the instance matting system 106 receives a guidance mask for each of the objects 206a-206c portrayed in the digital image 202. In some cases, the instance matting system 106 receives the guidance masks 208 along with the digital image 202. In some embodiments, the instance matting system 106 receives the guidance masks 208 from the same source from which the digital image 202 was received or from a different source. In certain implementations, however, the instance matting system 106 generates the guidance masks 208 from the digital image 202. For instance, in some instances, the instance matting system 106 uses a segmentation model to generate the guidance masks 208 from the digital image 202.

As further shown in FIG. 2, the instance matting system 106 generates refined matte predictions 210 from the digital image 202 and the guidance masks 208. In one or more embodiments, a refined matte prediction includes a matte that has been refined from one or more other mattes. In particular, in some embodiments, a refined matte prediction includes a matte that corresponds to an object portrayed in a digital image or video frame and has been generated from one or more other mattes that correspond to the object portrayed in the digital image or video frame. To illustrate, in some cases, a refined matte prediction includes a matte that results from a progressive refinement process implemented by the instance matting system 106. The process used by embodiments of the instance matting system 106 to generate a refined matte prediction will be discussed in more detail below.

In one or more embodiments, the instance matting system 106 generates a refined matte prediction for each of the objects 206a-206c portrayed in the digital image 202. For example, in some cases, the instance matting system 106 generates a refined matte prediction for one of the objects 206a-206c from the digital image 202 and the guidance mask corresponding to the object.

As illustrated, the instance matting system 106 uses an instance matting neural network 212 to generate the refined matte predictions 210. In one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

In one or more embodiments, an instance matting neural network includes a computer-implemented neural network that generates refined matte predictions or video frame mattes (video frame mattes will be discussed more below). In particular, in some embodiments, an instance matting neural network includes a neural network that generates one or more refined matte predictions for one or more objects portrayed in a digital image. To illustrate, in some cases, an instance matting neural network includes a neural network that analyzes a digital image portraying one or more objects and one or more guidance masks corresponding to the one or more objects and generates one or more refined matte predictions based on the analysis. In some implementations, an instance matting neural network includes a neural network that generates refined matte predictions and/or video frame mattes for one or more objects portrayed in a digital image. In particular, in some cases, an instance matting neural network generates one or more refined matte predictions and/or one or more video frame mattes for one or more video frames of a digital image. To illustrate, in some cases, an instance matting neural network analyzes a video frame portraying one or more objects and one or more guidance masks corresponding to the one or more objects and generates one or more refined matte predictions and/or one or more video frame mattes based on the analysis.

As further illustrated by FIG. 2, the instance matting system 106 provides a modified digital image 214 generated using one or more of the refined matte predictions 210 for display on the client device 204 (e.g., for display within a graphical user interface 216 of the client device 204). Indeed, in some cases, the instance matting system 106 provides the modified digital image 214 for display on the same computing device from which the digital image 202 was received. In some cases, the instance matting system 106 provides the modified digital image 214 for display on another computing device.

In one or more embodiments, the instance matting system 106 generates the modified digital image 214 using one or more of the refined matte predictions 210. For instance, as shown in FIG. 2, the object 206a has been removed from the modified digital image 214. Thus, in some embodiments, the instance matting system 106 generates the modified digital image 214 by removing the object 206a using the refined matte prediction corresponding to the object 206a. In certain embodiments, however, the instance matting system 106 provides the refined matte predictions 210 to another system and receives the modified digital image 214 from that system.

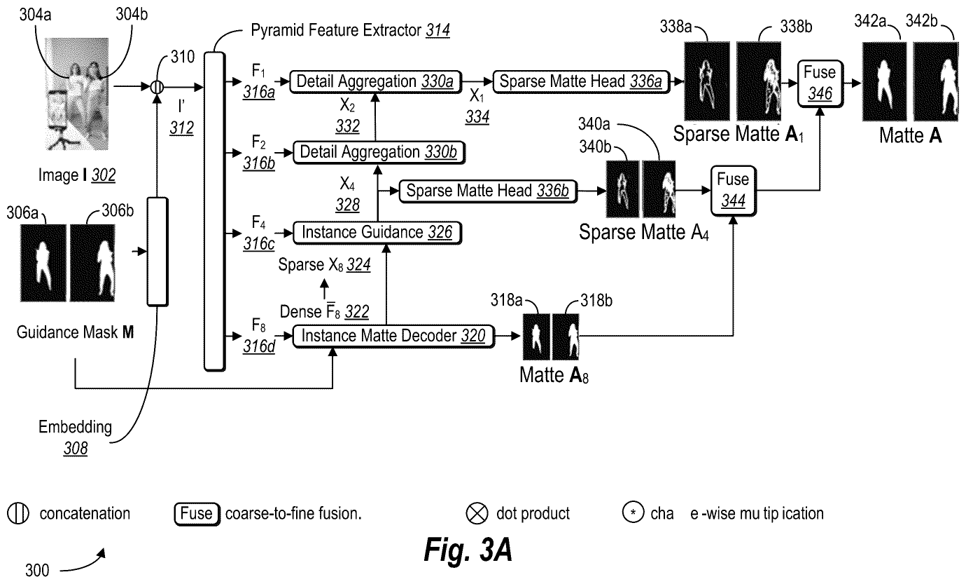

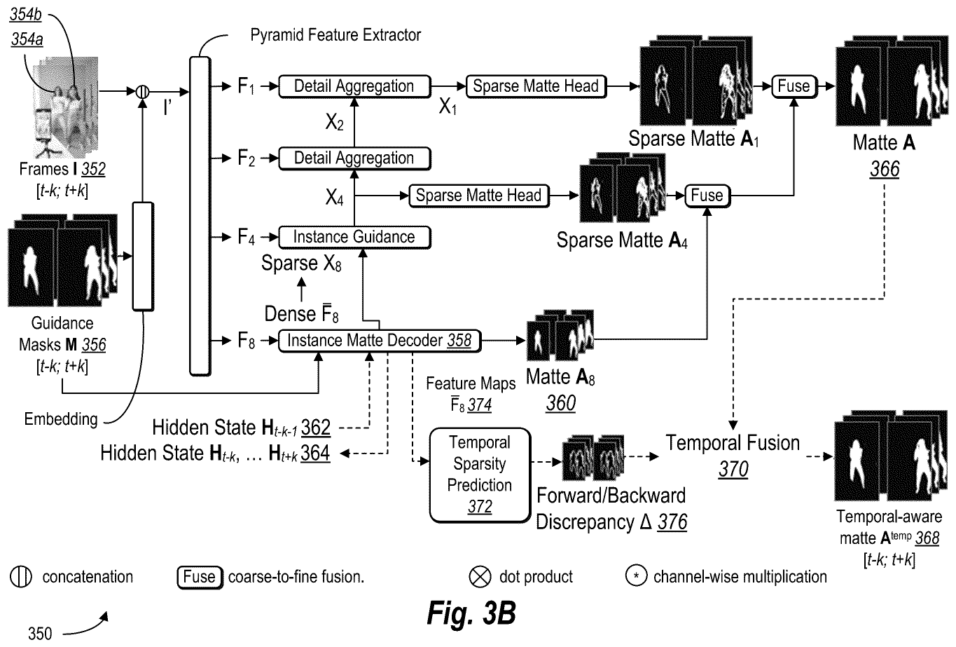

As previously mentioned, in one or more embodiments, the instance matting system 106 uses an instance matting neural network to generate mattes for digital images or digital videos. In particular, the instance matting system 106 uses an instance matting neural network to generate mattes for objects portrayed within digital images or digital videos. FIGS. 3A-3B illustrate the instance matting system 106 using an instance matting neural network to generate mattes in accordance with one or more embodiments.

In particular, FIG. 3A illustrates the instance matting system 106 using an instance matting neural network 300 to generate refined matte predictions for objects 304a-304b portrayed in a digital image 302 in accordance with one or more embodiments. Indeed, as shown in FIG. 3A, the instance matting system 106 provides the digital image 302 (represented as I) and guidance masks 306a-306b (represented as M) corresponding to the objects 304a-304b to the instance matting neural network 300.

As illustrated, the instance matting system 106 uses an embedding layer 308 of the instance matting neural network 300 to generate guidance embeddings (represented as E) from the guidance masks 306a-306b. The instance matting system 106 further concatenates the digital image 302 with the guidance embeddings via a concatenation operation 310 to generate a modified model input 312 (represented as I′). For instance, in one or more embodiments, I∈[0,255]^{T×3×H×W} and M∈{0,1}^{T×N×H×W} where T represents the number of video frames (e.g., T=1 where I refers to a digital image), N represents the number of objects, and H×W represents the resolution. Further, in some cases, each spatial-temporal location (x,y,t) in M—or spatial location (x,y) in M when I refers to a digital image—is a one-hot vector {0,1}^{N} highlighting the instance to which the location belongs. Thus, in some cases, the instance matting system 106 uses the embedding layer 308 to generate the guidance embeddings as follows:

$$E ( x , y ) = M ( x , y ) D \qquad ( 1 )$$

In equation 1, E∈ [symbol] ^{T×C}^{ₑ}^{×H×W} and D∈ [symbol] ^{N×C}^{ₑ}, where D represents embedding vectors and Cₑ represents an embedding dimension. In some embodiments, the instance matting system 106 uses equation 1 to embed the masked guidance into a learnable space (e.g., where Cₑ represents a dimension of the learnable space) when providing the guidance masks 306a-306b to the instance matting neural network 300. Indeed, as shown by equation 1, in some cases, the instance matting system 106 generates the guidance embeddings E by mapping embedding vectors D to pixels based on the guidance masks 306a-306b. As such, in some cases, the instance matting system 106 generates the modified model input 312 (via the concatenation of the digital image 302 and the guidance embeddings) as I′∈ [symbol] ^{T×(3+C}^{ₑ}^{)×H×W}.

Additionally, as shown in FIG. 3A, the instance matting system 106 provides the modified model input 312 to a pyramid feature extractor 314 of the instance matting neural network 300. As shown, the instance matting system 106 uses the pyramid feature extractor 314 to extract features from the modified model input 312. In particular, the instance matting system 106 extracts multiple subsets of features 316a-316d from the modified model input 312. In one or more embodiments, the instance matting system 106 determines each subset of features as Fₛ∈ [symbol] ^{T×C}^{ₛ}^{×H/sχW/s}. As illustrated, the instance matting system 106 uses s=1, 2, 4, 8, though the instance matting system 106 uses fewer, additional and/or alternative scale values in various embodiments.

As FIG. 3A illustrates, the instance matting system 106 uses the instance matting neural network 300 to generate coarse matte predictions 318a-318b from the subset of features 316d and the guidance masks 306a-306b. In particular, the instance matting system 106 uses an instance matte decoder 320 of the instance matting neural network 300 to generate the coarse matte predictions 318a-318b. More detail will be provided below regarding the instance matte decoder used by certain embodiments of the instance matting system 106.

In one or more embodiments, a coarse matte prediction includes a matte generated from coarse features. In particular, in some embodiments, a coarse matte prediction includes a prediction of a matte generated from low-scale features generated from a digital image and at least one corresponding guidance mask. For instance, in some cases, a coarse matte prediction includes a predicted matte generated using a subset of features associated with the lowest scale out of the features generated from a digital image and at least one corresponding guidance mask. In some embodiments, a coarse matte prediction includes a matte generated from an instance matte decoder of an instance matting neural network.

In one or more embodiments, the instance matting system 106 uses the instance matte decoder 320 of the instance matting neural network 300 to generate a coarse matte prediction each object portrayed in the digital image 302. Indeed, as indicated in FIG. 3A, the instance matting system 106 generates a coarse matte prediction 318a for the object 304a and generates a coarse matte prediction 318b for the object 304b. Further, in some embodiments, the instance matting system 106 uses the instance matte decoder 320 to generate each coarse matte prediction using a corresponding guidance mask. Indeed, as indicated by FIG. 3A, the instance matting system 106 generates the coarse matte prediction 318a using the guidance mask 306a and generates the coarse matte prediction 318b using the guidance mask 306b.

As shown, the instance matting system 106 determines a set of dense features 322 for the digital image 302. In particular, the instance matting system 106 uses the instance matte decoder 320 to determine the set of dense features 322. In some cases, the set of dense features 322 include enriched features from the subset of features 316d (indeed, in some cases, the subsets of features 316a-316d include dense features). Determining the set of dense features 322 using the instance matte decoder 320 will be discussed further below.

In one or more embodiments, dense features include features associated with a high level of detail. Indeed, in some cases, dense features are relatively more detailed when compared to other features (e.g., sparse features). For instance, in some cases, a set of dense features that corresponds to a digital image includes relatively more detail with respect to the digital image. To illustrate, in certain implementations, a set of dense features corresponding to a digital image includes detail for the entire digital image (e.g., every pixel of the digital image) or at least a relatively larger portion of the digital image (e.g., a relatively larger set of image pixels).

As further shown in FIG. 3A, the instance matting system 106 determines a set of sparse features 324 for the digital image 302. In particular, the instance matting system 106 determines the set of sparse features 324 from the set of dense features 322. Determining the set of sparse features 324 from the set of dense features 322 will be discussed further below.

In one or more embodiments, sparse features include features associated with a low level of detail. Indeed, in some cases, sparse features are relatively less detailed when compared to other features (e.g., dense features). For instance, in some cases, a set of sparse features that corresponds to a digital image includes relatively less detail with respect to the digital image. To illustrate, in certain implementations, a set of sparse features corresponding to a digital image includes detail for a relatively small portion of the digital image (e.g., a relatively smaller set of image pixels). For example, in some instances, a set of sparse features include features for pixels of a digital image having uncertain classifications, such as pixels that are at or adjacent to a border between an object portrayed in a digital image and other portions of the digital image. In some implementations, sparse features include instance-specific features.

As further shown in FIG. 3A, the instance matting system 106 uses an instance guidance model 326 of the instance matting neural network 300 to generate a set of sparse features 328 from the set of sparse features 324 and the subset of features 316c. The instance guidance model 326 will be discussed in more detail below.

Further, as shown, the instance matting system 106 uses detail aggregation 330b to generate a set of sparse features 332 from the set of sparse features 328 and the subset of features 316b. Additionally, the instance matting system 106 uses detail aggregation 330a to generate a set of sparse features 334 from the set of sparse features 332 and the subset of features 316a. Using detail aggregation will also be discussed in more detail below.

As FIG. 3A, illustrates, the instance matting system 106 uses a sparse matte head 336a to generate intermediate matte predictions 338a-338b from the set of sparse features 324. In particular, the instance matting system 106 generates the intermediate matte prediction 338a for the object 304a of the digital image 302 and generates the intermediate matte prediction 338b for the object 304b of the digital image 302.

In one or more embodiments, an intermediate matte prediction includes a matte generated from features that are higher in scale than features from which a coarse matte prediction is generated. In particular, in some embodiments, an intermediate matte prediction includes a prediction of a matte generated from higher-scale features generated from a digital image and at least one corresponding guidance mask. In some embodiments, an intermediate matte prediction includes a matte generated from a sparse matte head of an instance matting neural network. In certain instances, an intermediate matte prediction includes a matte that fuses with a coarse matte prediction and one or more additional intermediate matte predictions (e.g., of different scales) to generate a refined matte prediction.

Similarly, as shown, the instance matting system 106 uses a sparse matte head 336b to generate intermediate matte predictions 340a-340b from the set of sparse features 332. In particular, the instance matting system 106 generates the intermediate matte prediction 340a for the object 304a of the digital image 302 and generates the intermediate matte prediction 340b for the object 304b of the digital image 302.

In one or more embodiments, each of the sparse matte heads 336a-336b includes two sparse convolutional layers with one or more intermediate normalization and activation (e.g., leaky ReLU) layers. In some cases, each of the sparse matte heads 336a-336b uses sigmoid activation to provide the final prediction (e.g., the corresponding intermediate matte predictions). Additionally, in certain embodiments, each of the sparse matte heads 336a-336b assigns a value of zero to non-refined locations in the dense prediction.

As illustrated in FIG. 3A, the instance matting system 106 progressively refines the coarse matte predictions 318a-318b to generate the refined matte predictions 342a-342b. In particular, the instance matting system 106 progressively refines the coarse matte prediction 318a to generate the refined matte prediction 342a and progressively refines the coarse matte prediction 318b to generate the refined matte prediction 342b.

In one or more embodiments, the instance matting system 106 uses the progressive refinement of the instance matting neural network 300 to improve the details at uncertain locations from the coarse matte predictions 318a-318b where the uncertain locations are represented as U={uₚ=(x,y,t,i)|0<A₈(uₚ)<1}∈ [symbol] ^{P×4}. As previously mentioned, the instance matting system 106 transforms the set of dense features 322 (e.g., dense features as enriched by the instance matte decoder 320) to the set of sparse features 324 (e.g., instance-specific features). In some cases, the instance matting system 106 determines transformed features at uncertain location as follows:

$${X}_{8} ( x , y , t , i ) = MLP ( {\overline{F}}_{8} ( x , y , t ) \times {T}_{i} ) \qquad ( 2 )$$

In one or more embodiments, determining transformed features at uncertain locations reduces the memory and computational costs of determining the transformed features.

Additionally, the instance matting system 106 uses the instance guidance model 326 to assist in the progressive refinement by combining coarser instance specific sparse features (e.g., the set of sparse features 324) with finer image features (e.g., the subset of features 316c). The instance matting system 106 aggregates the set of sparse features 328 produced by the instance guidance model 326 with other dense features (e.g., the subset of features 316a and the subset of features 316b) to enable the generation of matte predictions (e.g., the intermediate matte predictions 340a-340b and the intermediate matte predictions 338a-338b) with gradual detail improvement.

As shown, the instance matting system 106 also performs fusion operations as part of the progressive refinement. In particular, the instance matting system 106 uses the fusion operation 344 to fuse the coarse matte predictions 318a-318b with the intermediate matte predictions 340a-340b. The instance matting system 106 further performs a fusion operation 346 to fuse the output of the fusion operation 344 with the intermediate matte predictions 338a-338b.

In one or more embodiments, the instance matting system 106 uses the progressive refinement approach described in U.S. patent application Ser. No. 17/177,595 filed on Feb. 17, 2021, entitled GENERATING REFINED ALPHA MATTES UTILIZING GUIDANCE MASKS AND A PROGRESSIVE REFINEMENT NETWORK, which is incorporated herein by reference in its entirety. For instance, in some cases, the instance matting system 106 uses the progressive refinement network described in U.S. patent application Ser. No. 17/177,595 to perform the fusion operation 344 and/or the fusion operation 346.

Through the progressive refinement described above (including the fusion operation 344 and the fusion operation 346), the instance matting system 106 generates the refined matte predictions 342a-342b. Thus, in one or more embodiments, the instance matting system 106 uses the instance matting neural network 300 to generate the refined matte predictions 342a-342b from the digital image 302 and the guidance masks 306a-306b. In particular, the instance matting system 106 generates the refined matte predictions 342a-342b for the objects 304a-304b portrayed in the digital image 302.

FIG. 3B illustrates the instance matting system 106 using an instance matting neural network 350 to generate refined matte predictions for objects 354a-354b portrayed in a digital video in accordance with one or more embodiments. Indeed, as shown in FIG. 3B, the instance matting system 106 provides a subset of video frames 352 of a digital video (represented as I) and guidance masks 356 (represented as M) corresponding to the objects 354a-354b to the instance matting neural network 350.

In particular, FIG. 3B shows the subset of video frames 352 including video frames within a temporal window of size k. Thus, FIG. 3B shows the instance matting system 106 providing video frames within the subset [t−k; t+k] to the instance matting neural network 350. In some implementations, the instance matting system 106 generates refined matte predictions for every video frame within the digital video (or at least a set of video frames that is larger than the subset [t−k; t+k]), and FIG. 3B is merely representative of using the instance matting neural network 350 to generate refined matte predictions for a particular subset of video frames. For instance, in some cases, the instance matting system 106 uses the subset of video frames 352 to generate refined matte predictions for a target video frame t.

In one or more embodiments, the instance matting system 106 uses the instance matting neural network 350 to generate a refined matte prediction for each object portrayed in each video frame from the subset of video frames 352 of the digital video. Thus, in some cases, the instance matting system 106 generates multiple refined matte predictions for a given object—one for each video frame portraying that object. Additionally, in some instances, the instance matting system 106 generates multiple refined matte predictions for a given video frame-one for each object portrayed therein.

As further shown in FIG. 3B, the guidance masks 356 includes a guidance mask for each object portrayed in each video frame from the subset of video frames 352 of the digital video. Thus, in some cases, the guidance masks 356 include multiple guidance masks for a given object—one for each video frame portraying that object. Additionally, in some instances, the guidance masks 356 includes multiple guidance masks for a given video frame—one for each object portrayed therein.

As indicated by FIG. 3B, the instance matting system 106 uses the instance matting neural network 350 similar to the neural network 300 discussed with respect to FIG. 3A with a few notable differences. For instance, as shown in FIG. 3B, the instance matting system 106 uses an instance matte decoder 358 of the instance matting neural network 350 to generate coarse matte predictions 360 for the objects 354a-354b (e.g., one coarse matte prediction for each object portrayed in each video frame of the subset of video frames 352). For instance, in some cases, the instance matting system 106 generates a coarse matte prediction for a particular object portrayed in a particular video frame using the video frame and a guidance mask corresponding to the object in the video frame (e.g., using features extracted from the video frame and guidance mask).

As shown in FIG. 3B, however, the instance matting system 106 uses a hidden state 362 (Hₜ₋ₖ₋₁) from the previous window as an input to the instance matte decoder 358. In some cases, the instance matting system 106 sets the value of the initial hidden state H₀ to zero. The instance matting system 106 further uses the instance matte decoder 358 to output one or more hidden states 364 (Hₜ₋ₖ . . . Hₜ₊ₖ) from the current window.

Indeed, in some implementations, the instance matting system 106 uses the instance matte decoder 358 to implement temporal aggregation at the feature level. In particular, the instance matting system 106 uses the instance matte decoder 358 to process the subset of video frames 352 to ensure consistency among the features of the video frames within the subset of video frames 352. Indeed, as shown in FIG. 3B, the instance matting system 106 uses the instance matte decoder 358 to process the video frames {t−k, . . . t+k} and fuse the features associated with the target video frame t with the features associated with at least one adjacent video frame.

In one or more embodiments, a video frame is adjacent to another video frame (e.g., a target video frame) if the video frame is within a designated proximity of the other video frame. In certain embodiments, a video frame is adjacent to another video frame if the video frame is next to the other video frame withing a sequence of video frames. For example, in some cases, a video frame is adjacent to another video frame if the video frame immediately precedes or follows the other video frame. In some cases, a video frame is adjacent to another video frame if the video frame is within k video frames of the other video frame. In certain implementations, the instance matting system 106 sets k=1 so that a video frame includes two adjacent video frames (i.e., one preceding video frame and one following video frame), though the instance matting system 106 sets k to various values in various embodiment.

In some cases, the instance matting system 106 uses the instance matte decoder 358 to fuse the features of the target video frame t and the one or more adjacent video frames via forward and backward aggregations. More detail regarding the fusing of features using an instance matte decoder will be discussed below.

As shown in FIG. 3B, the instance matting system 106 uses the instance matting neural network 350 to generate refined matte predictions 366 for the objects 354a-354b in the subset of video frames 352 (e.g., one refined matte prediction for each object portrayed in each video frame of the subset of video frames 352). As further shown, however, the instance matting system 106 fuses the refined matte predictions 366 via a temporal fusion 370 to generate video frame mattes 368 for the objects 354a-354b in the subset of video frames 352 (e.g., one video frame matte for each object portrayed in each video frame of the subset of video frames 352).

In one or more embodiments, a video frame matte includes a matte generated for a video frame by fusing at least two refined matte predictions. In particular, in some embodiments, a video frame matte includes a matte for an object in a target video frame by fusing a refined matte prediction generated for the object in the target video frame with a refined matte prediction for the object in at least one adjacent video frame. To illustrate, in some cases, a video frame matte includes a matte generated for an object in a target video frame by fusing the refined matte prediction generated for the object in the target video frame with a refined matte prediction generated for the object in the preceding and subsequent video frames.

Indeed, in some implementations, the instance matting system 106 uses the instance matting neural network 350 to implement temporal aggregation at the matte level. In particular, the instance matting system 106 uses the instance matting neural network 350 to process the subset of video frames 352 to ensure consistency among the output mattes of the video frames within the subset of video frames 352. Indeed, as shown in FIG. 3B, the instance matting system 106 uses the instance matting neural network 350 to c and fuse the refined matte prediction generated for the target video frame t with the refined matte prediction generated for at least one adjacent video frame.

As shown in FIG. 3B, the instance matting system 106 fuses the refined matte predictions 366 by using the instance matting neural network 350 to determine sparsity predictions 372 from a set of features 374 (e.g., enriched features) output by the instance matte decoder 358. For example, in some cases, the instance matting system 106 uses a convolutional network with a sigmoid activation to process features (e.g., enriched features) for video frame t−1 and video frame t and output a matte discrepancy 376 represented as Δ(t)∈{0,1}^{H×W}. For each video frame t, with Δ(t) and Δ(t+1), the instance matting system 106 determines the forward propagation A^{f} and the backward propagation A^{b} and rejects the propagation of misaligned regions via the temporal fusion 370 to determine a temporal aware output A^{temp}.

Thus, the instance matting system 106 uses the temporal fusion 370 of the instance matting neural network 350 to generate the video frame mattes 368. In particular, the instance matting system 106 generates a video frame matte (e.g., the temporal aware output A^{temp}) for the video frame t. More specifically, the instance matting system 106 generates a video frame matte for an object portrayed in the video frame t. Indeed, in one or more embodiments, the instance matting system 106 fuses the refined matte predictions generated for a particular object to generate the video frame matte for the object in the video frame t.

By generating the video frame mattes 368 using aggregations at both the feature level and the matte level, the instance matting system 106 operates with improved accuracy when compared to conventional systems. In particular, the instance matting system 106 generates mattes with greater temporal consistency across frames. Indeed, as mentioned, many conventional systems typically rely on feature level aggregation, but the features used can be sensitive and lead to inconsistent results. Thus, by incorporating matte-level aggregation with the feature-level aggregation, the instance matting system 106 provides better temporal consistency.

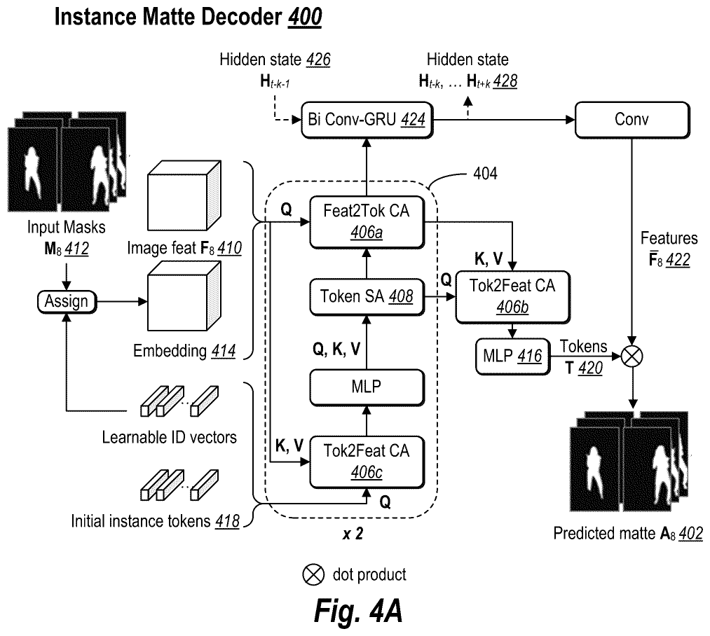

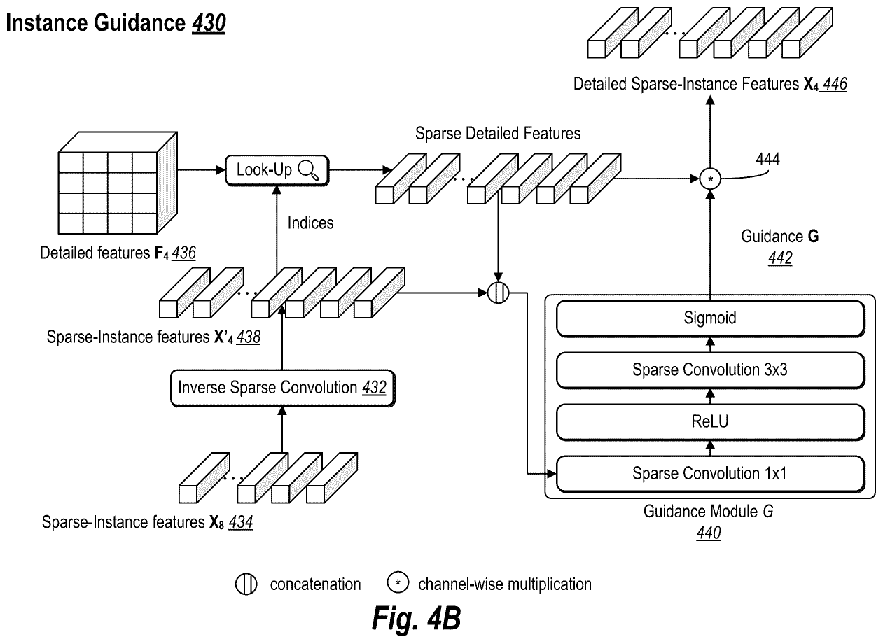

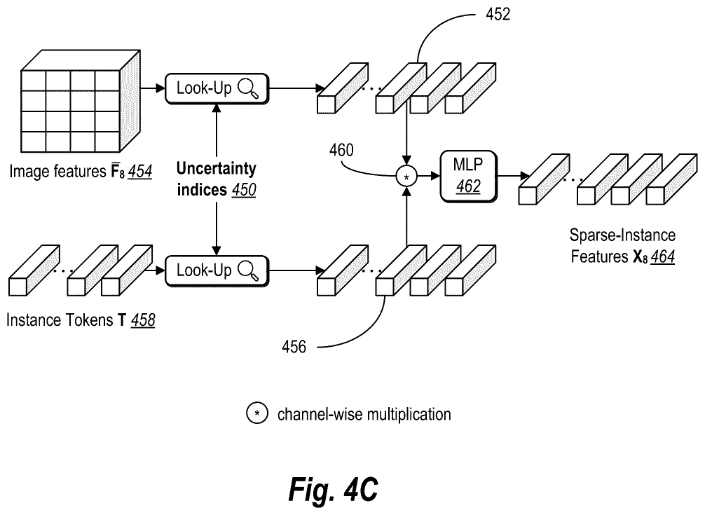

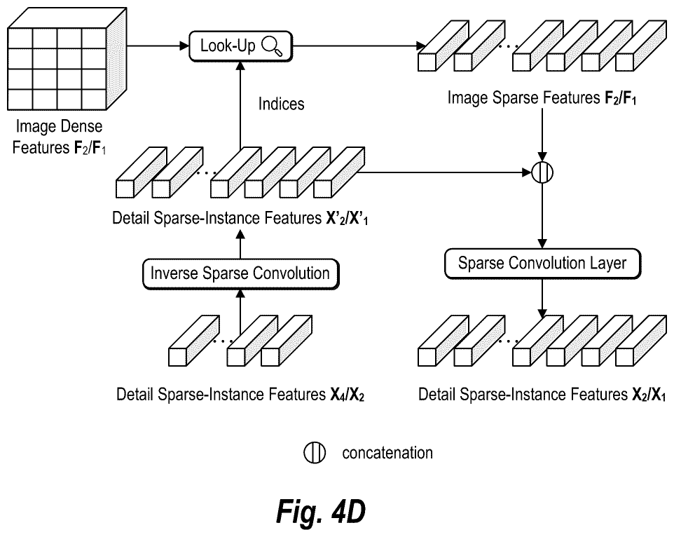

As mentioned above, the instance matting neural network used by the instance matting system 106 in various embodiments includes various components for generating refined matte predictions and/or video frame mattes. FIGS. 4A-4D illustrate the various components incorporated within the instance matting neural network used by the instance matting system 106 in accordance with one or more embodiments.

For instance, FIG. 4A illustrates an instance matte decoder 400 incorporated within an instance matting neural network in accordance with one or more embodiments. As shown in FIG. 4A, the instance matte decoder 400 incorporates transformer-style attention to generate coarse matte predictions 402. For instance, as shown, the instance matte decoder 400 uses an attention block 404 to implement scaled dot-product attention as follows:

$$Attention ( Q , K , V ) = softmax ( \frac{{QK}^{Trans}}{\sqrt{C}} ) V \qquad ( 3 )$$

In equation 3, queries Q∈ [symbol] ^{L×C}, keys K∈ [symbol] ^{S×C}, and values V∈ [symbol] ^{S×C}. In one or more embodiments, the instance matting system 106 uses stacked cross-attention and self-attention operations (i.e., layers) within the instance matte decoder 400 to exchange information between learnable instance tokens 418 T={Tᵢ|1≤i≤N}∈ [symbol] ^{C}^{₈} and features 410. In some cases, the instance matting system 106 uses the guidance masks 412 to aid in cross-attention, providing embeddings 414 E∈ [symbol] ^{T×C}^{ₛ}^{×H/sχW/s} from a learnable bank of embeddings D∈ [symbol] ^{N×C}^{ₛ}.

In one or more embodiments, the instance matting system 106 determines Q and (K,V) from different sources for the cross-attention operations 406a-406c but uses the same values for Q, K, and V for the self-attention operation 408. For instance, in one or more embodiments, the instance matting system 106 uses T as the query and the features 410 as the key and value for the cross-attention operation 406c but swaps their roles for the cross-attention operation 406a. Additionally, in some cases, the instance matting system 106 uses only T for the self-attention operation 408.

As indicated by FIG. 4A, the instance matting system 106 includes two instances of the attention block 404 within the instance matte decoder 400 (or repeats the attention block 404 during processing). The instance matting system 106 then uses a cross-attention operation 406b and a multi-layer perceptron layer 416 following the attention block 404. In some cases, this design enables instance tokens to acquire semantic information from image features and distribute instance information to similar regions guided by the guidance masks 412. Indeed, in certain implementations, the final tokens 420 contain instance information, and the enriched features 422 includes separable semantic features. As shown in FIG. 4A, the instance matting system 106 uses the instance matte decoder 400 to generate the coarse matte predictions 402 by determining a dot product between the final tokens 420 and the enriched features 422 with a sigmoid activation applied.

As further shown in FIG. 4A, when generating the coarse matte predictions 402 for video frames of a digital video, the instance matting system 106 uses a bidirectional convolutional gated recurrent unit 424 of the instance matte decoder 400 to ensure bidirectional consistency among the features of adjacent video frames. As shown, the instance matting system 106 provides the hidden state 426 from the previous window as part of the input to the bidirectional convolutional gated recurrent unit 424. As further shown, the instance matting system 106 produces one or more hidden states 428 from the output of the bidirectional convolutional gated recurrent unit 424.

As illustrated by FIG. 4A, the instance matting system 106 uses the bidirectional convolutional gated recurrent unit 424 to process the video frames {t−k, . . . t+k}. In some cases, the instance matting system 106 overlaps windows of video frames (e.g., by a determined number of video frames). In some cases, the instance matting system 106 uses the bidirectional convolutional gated recurrent unit 424 to fuse the features of target video frame t with the features of at least one adjacent video frame and uses forward and backward aggregations in doing so. Thus, in some cases, the instance matting system 106 uses the instance matte decoder 400 to implement aggregation at the feature level.

FIG. 4B illustrates an instance guidance model 430 incorporated within an instance matting neural network in accordance with one or more embodiments. In one or more embodiments, an instance guidance model includes a neural network or neural network component that transforms generic image information to instance-specific features. In particular, in some embodiments, an instance guidance model includes a neural network or neural network component that guides a set of image detail features towards specific instances. To illustrate, in some cases, an instance matting neural network includes a neural network or neural network component that is incorporated within an encoder-decoder architecture where the encoder compresses generic image information, the decoder transforms features to instance-wise predictions, and the instance guidance model guides the transformation process.

As illustrated in FIG. 4B, the instance matting system 106 uses the instance guidance model 430 to apply an inverse sparse convolution 432 to features 434 (represented as X₈) to match the spatial scale of features 436 (represented as F₄), which results in the features 438 (represented as

$${X}_{4}^{′} ) .$$

In some cases, for each entry j in the features 438 and its corresponding feature in the features 436, the instance matting system 106 uses a guidance module 440 to compute a guidance score 442 represented as G∈[0,1]^{C}^{₄} and further uses a channel-wise multiplication operation 444 to channel-wise multiply the guidance score 442 with the features 436 to produce the features 446 (represented as X₄) as follows:

$${X}_{4} ( j ) = 𝒢 ( \{ {X}_{4}^{′} ( j ) ; {F}_{4} ( j ) \} ) * {F}_{4} ( j ) \qquad ( 4 )$$

In equation 4, the operator ; denotes concatenation along the feature dimension. Further, [symbol] represents a series of sparse convolutions with sigmoid activation as the guidance module 440 of FIG. 4B indicates.

In one or more embodiments, by incorporating the instance guidance model 430 within the instance matting neural network, the instance matting system 106 operates with improved efficiency when compared to many conventional systems. For instance, by incorporating the instance guidance model 430, the instance matting system 106 enables the instance matting neural network to generate refined matte predictions and/or video frame mattes for multiple objects of a digital image or digital video in a single pass compared to many conventional systems that require multiple passes. Indeed, as the instance guidance model 430 transforms generic image information to instance-specific features, one or more embodiments of the instance matting system 106 use the instance guidance model 430 to determine which features of a digital image or video frame correspond to which objects, facilitating single pass processing.

FIG. 4C illustrates the instance matting system 106 converting dense features into sparse features via an instance matting neural network in accordance with one or more embodiments.

As previously mentioned, in one or more embodiments, the instance matting system 106 uses sparse features to focus on uncertain locations. Thus, as shown in FIG. 4C, the instance matting system 106 uses uncertainty indices 450 where each uncertainty index (x,y,t,i)∈U. In particular, as shown, for each uncertainty index, the instance matting system 106 extracts feature vectors 452 (represented as F̅(x,y,t)) from the set of features 454 (e.g., the enriched dense features F̅₈). Further, for each uncertainty index, the instance matting system 106 extracts instance token vectors 456 (represented as Tᵢ) from the instance tokens 458 (represented as T). The instance matting system 106 uses a channel-wise multiplication operation 460 to channel-wise multiply the vectors, emphasizing the channels relevant to each instance. The instance matting system 106 uses a multi-layer perceptron layer 462 to convert the output of the channel-wise multiplication operation 460 into the set of features 464 (e.g., the sparse, instance-specific features X₈).

By converting dense features into sparse features, the instance matting system 106 operates with improved efficiency when compared to many conventional systems. For instance, the instance matting system 106 uses sparse convolutions that reduce the computing resources used to generate refined matte predictions and/or video frame mattes. Further, focusing on the uncertain locations represented by the sparse features facilitates refinement to enable generating refined matte predictions and/or video frame mattes in a single pass.

FIG. 4D illustrates the instance matting system 106 performing detail aggregation of features in accordance with one or more embodiments. As indicated in FIG. 4D (and as briefly discussed above with reference to FIG. 3A), the instance matting system 106 uses detail aggregation to aggregate features from different scales. In some cases, the instance matting system 106 performs the detail aggregation by upscaling a set of features (e.g., a set of sparse features) and merging the upscaled features with the corresponding higher scale of features. In some cases, the instance matting system 106 uses pre-computed downscale indices from dummy sparse convolutions on the full input digital image or video frame.

Thus, the instance matting system 106 implements an instance matting neural network to generate refined matte predictions and/or video frame mattes for objects portrayed in digital images and/or digital videos. In various embodiments, the instance matting system 106 trains the instance matting neural network to generate mattes for objects using various losses.

For example, in certain implementations, the instance matting system 106 uses [symbol] ₁ to train the instance matting neural network for reconstruction, [symbol] ₗₐₚ to train for detail, and [symbol] _{grad} to train for smoothness. In some cases, the instance matting system 106 also uses an attention loss [symbol] ₐₜₜ to supervise the affinity score matrix between instance tokens T (as the query Q) and the image features F (as the key K and value V). Further, in some embodiments, the instance matting system 106 assigns customized weights W₈ for losses at scale s=8 to prioritize uncertain locations, enabling accurate coarse-level predictions, which facilitate the accurate determination of uncertain locations for the progressive refinement process.

In some implementations, the instance matting system 106 uses one or more additional or alternative losses to train the instance matting neural network for generating mattes for objects portrayed in digital videos. For example, in some cases, the instance matting system 106 uses the direct temporal gradients on sum of squared differences (dtSSD) loss to train for temporal consistency. In some instances, the instance matting system 106 further uses an L1 loss for alpha matte discrepancy. In certain cases, the L1 loss compares the predicted Δ(t) with the ground truth Δ^{gt}(t)=maxᵢ(|A^{gt}(t−1,i)−A^{gt}(t,i)|>β), where β=0.001 to simplify the problem to binary pixel classification.

As previously discussed, in one or more embodiments, the instance matting system 106 utilizes the mattes generated by the instance matting neural network to modify the corresponding digital images or digital videos. For instance, in some embodiments, the instance matting system 106 uses one or more refined matte predictions generated for one or more digital objects portrayed in a digital image to modify the digital image. Similarly, in some cases, the instance matting system 106 uses video frame mattes generated for one or more objects portrayed across video frames of a digital video to modify those video frames.

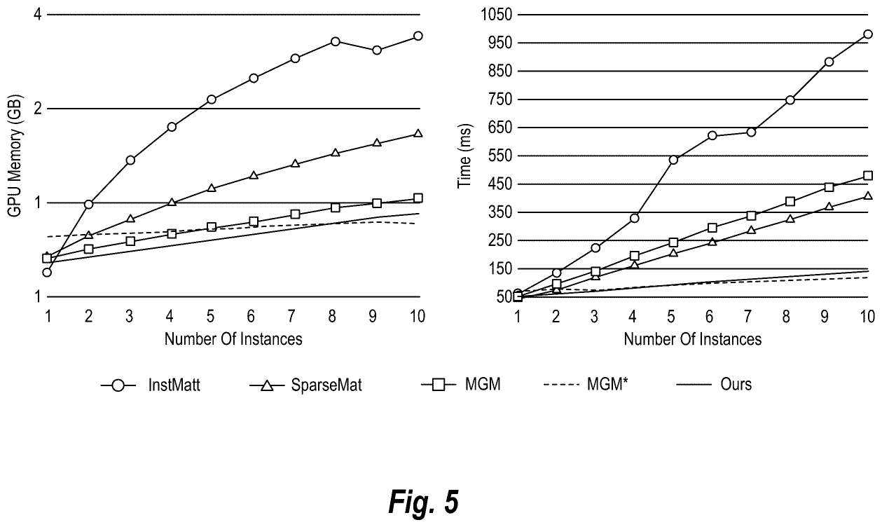

As previously mentioned, the instance matting system 106 provides various advantages compared to many conventional systems. Researchers have conducted studies to determine the effectiveness of one or more embodiments of the instance matting system 106 compared to various conventional systems. FIGS. 5-7 illustrates experimental results regarding the effectiveness of the instance matting system 106 in accordance with one or more embodiments.

In particular, FIG. 5 illustrates graphs reflecting experimental results regarding the efficiency of the instance matting system 106 in generating mattes for objects portrayed in a digital image or video frame in accordance with one or more embodiments. The graphs compare the performance of the instance matting system 106 with various baseline models, including (i) the InstMatt model described by Yanan Sun et al., Human Instance Matting via Mutual Guidance and Multi-instance Refinement, CVPR, 2022; (ii) the SparseMat model described by Yanan Sun et al., Ultrahigh Resolution Image/Video Matting with Spatio-Temporal Sparsity, CVPR 2023; (iii) the mask-guided matting (MGM) model described by Qihang Yu et al., Mask Guided Matting via Progressive Refinement Network, CVPR 2021; and (iv) a modified version of the MGM model (labeled MGM*) configured to handle up to ten instances.

As shown by the graphs of FIG. 5, the instance matting system 106 operates with significantly better efficiency when compared to the InstMatt, SparseMat, and MGM models in terms of both time and GPU memory consumption. Indeed, while the time and memory required by these models increases significantly with the number of objects, the time and memory required by the instance matting system 106 remains relatively stable with only slight increases. The performance of the instance matting system 106 is comparable to the MGM* model, which is limited to ten instances.

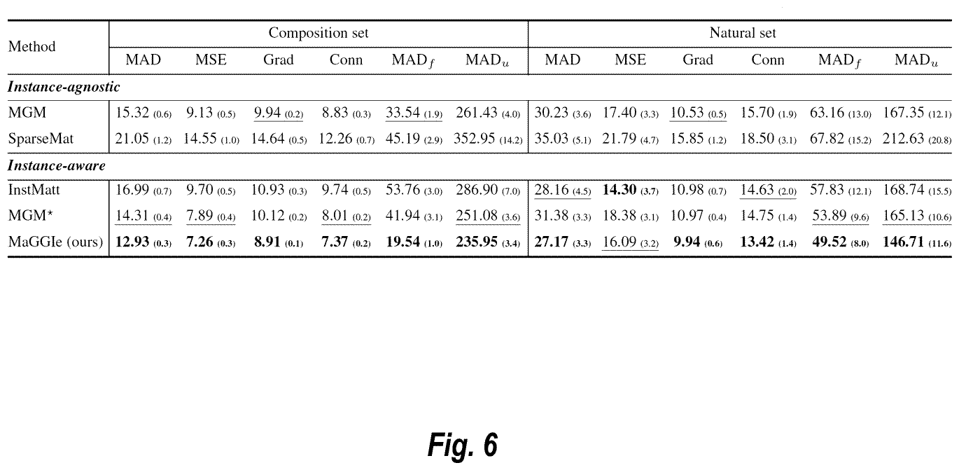

FIG. 6 illustrates a table reflecting experimental results regarding the accuracy with which the instance matting system 106 (labeled MaGGIe) generates mattes for objects portrayed in digital images in accordance with one or more embodiments. The table of FIG. 6 groups the tested models, with the upper group having models that predict each instance separately and the lower group having models that use instance information.

The table of FIG. 6 compares the performance of the tested models on both natural images and composite images. The table further measures the performance of the tested models using mean absolute differences (MAD), mean squared error (MSE), gradient (Grad), and connectivity (Conn). The table also provides measurements for the foreground (MAD_{f}) and unknown (MADᵤ) regions, which were determined by estimating the trimap on the ground truth of the test data used for the experiment. Because the images of the test data included multiple objects, the metrics were calculated for each object individually and then averaged. In the table, bolded values indicate the best performance while underlined values indicate the second best.

As shown by the table of FIG. 6, the instance matting system 106 outperformed the other tested models in almost every metric used. Where the instance matting system 106 did not provide the best performance (i.e., the MSE metric for the set of natural images), the instance matting system 106 provided the second-best performance.

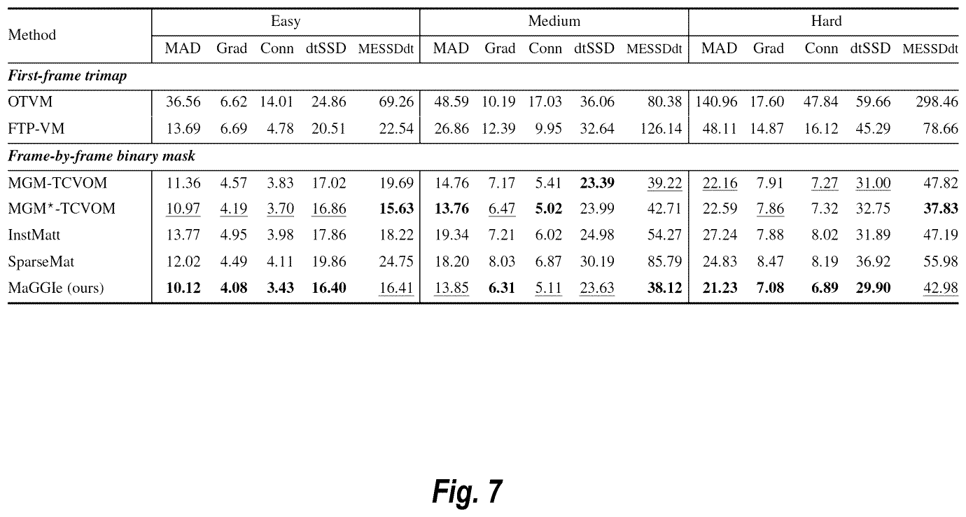

FIG. 7 illustrates a table reflecting experimental results regarding the accuracy with which the instance matting system 106 (labeled MaGGIe) generates mattes for objects portrayed in digital videos in accordance with one or more embodiments. The table of FIG. 7 includes the direct temporal gradients on sum of squared differences (dtSSD) and the mean squared error over structural similarities for direct temporal gradients (MESSDdt) metrics to assess the temporal consistency of the generated mattes across frames. The table further compares the performance of the tested models on three sets of digital videos: a first set (labeled Easy) that includes two or three objects with no overlap in each video; a second set (labeled Medium) that includes up to five objects per video with occlusion ranging from five to fifty percent per video frame; and a third set (labeled Hard) that also includes up to five objects per video but with occlusion ranging from fifty to eighty-five percent per video frame. Again, bolded values indicate the best performance while underlined values indicate the second best.

As shown by the table of FIG. 7, the instance matting system 106 reduces error when compared to the other tested models across most of the metrics. Notably, the instance matting system 106 excels in temporal consistency, evidenced by its top performance in dtSSD for both easy and hard sets, and in MESSDdt for the medium set. Additionally, the instance matting system 106 shows superior performance in capturing fine details as indicated by its leading scores in the Grad metric across all test sets.

Turning now to FIG. 8, additional detail will now be provided regarding various components and capabilities of the instance matting system 106. FIG. 8 illustrates the instance matting system 106 implemented by the computing device 800 (e.g., the server device(s) 102 and/or one of the client devices 110a-110n discussed above with reference to FIG. 1). Additionally, the instance matting system 106 is part of the image/video editing system 104. As shown, in one or more embodiments, the instance matting system 106 includes, but is not limited to, a neural network training engine 802, a matte generator 804, an image/video editor 806, and data storage 808 (which includes an instance matting neural network 810).

As just mentioned, and as illustrated in FIG. 8, the instance matting system 106 includes the neural network training engine 802. In one or more embodiments, the neural network training engine 802 trains a neural network to generate mattes for objects portrayed in digital images and/or digital videos. In some embodiments, the neural network training engine 802 trains an instance matting neural network to generate refined matte predictions and/or video frame mattes. In some cases, the neural network training engine 802 trains the instance matting neural network to implement aggregation at the feature and matte levels to ensure temporal consistency when generating mattes for objects portrayed in digital videos.

Additionally, as shown in FIG. 8, the instance matting system 106 includes the matte generator 804. In one or more embodiments, the matte generator 804 generates mattes for objects portrayed in digital images and/or digital videos. In particular, in some embodiments, the matte generator 804 generates refined matte predictions and/or video frame mattes. In some instances, the matte generator 804 employs a trained instance matting neural network to generate the mattes.

As shown in FIG. 8, the instance matting system 106 further includes the image/video editor 806. In one or more embodiments, the image/video editor 806 modifies digital images and/or digital videos. In particular, in some embodiments, the image/video editor 806 modifies a digital image using one or more refined matte predictions generated for one or more objects portrayed in the digital image. Similarly, in some cases, the image/video editor 806 modifies a digital video using video frame mattes generated for one or more objects portrayed in the video frames of the digital video.

As shown in FIG. 8, the instance matting system 106 further includes data storage 808. In particular, data storage 808 includes the instance matting neural network 810, such as the instance matting neural network trained by the neural network training engine 802 and implemented by the matte generator 804.

Each of the components 802-810 of the instance matting system 106 optionally include software, hardware, or both. For example, in some cases, the components 802-810 include one or more instructions stored on a computer-readable storage medium and executable by processors of one or more computing devices, such as a client device or server device. When executed by the one or more processors, the computer-executable instructions of one or more embodiments of the instance matting system 106 cause the computing device(s) to perform the methods described herein. Alternatively, in some instances, the components 802-810 include hardware, such as a special-purpose processing device to perform a certain function or group of functions. Alternatively, in certain implementations, the components 802-810 of the instance matting system 106 include a combination of computer-executable instructions and hardware.

Furthermore, in one or more embodiments, the components 802-810 of the instance matting system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 802-810 of the instance matting system 106 are implemented as a stand-alone application, such as a desktop or mobile application. Furthermore, in some cases, the components 802-810 of the instance matting system 106 are implemented as one or more web-based applications hosted on a remote server device. Alternatively, or additionally, the components 802-810 of the instance matting system 106 are implemented in a suite of mobile device applications or “apps.” For example, in one or more embodiments, the instance matting system 106 comprises or operates in connection with digital software applications such as ADOBE® PREMIERE®, ADOBE® AFTER EFFECTS®, or ADOBE® FIREFLY. The foregoing are either registered trademarks or trademarks of Adobe Inc. in the United States and/or other countries.

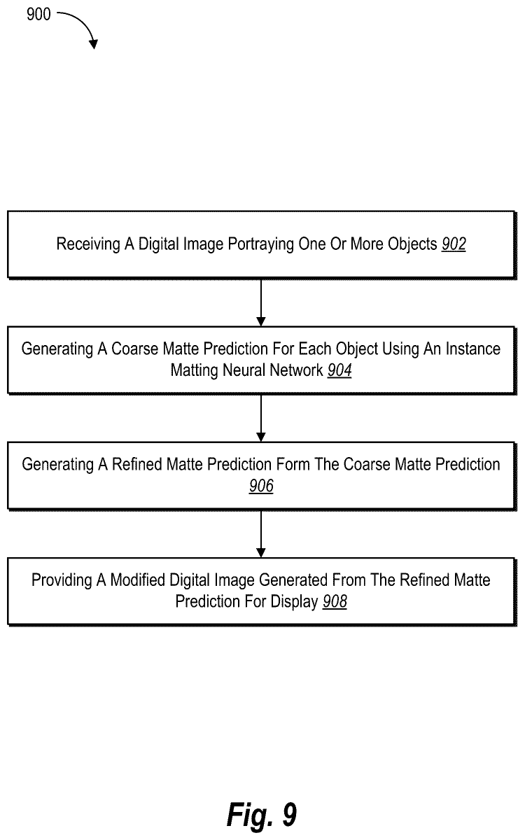

FIGS. 1-8, the corresponding text, and the examples provide a number of different methods, systems, devices, and non-transitory computer-readable media of the instance matting system 106. In addition to the foregoing, one or more embodiments are also described in terms of flowcharts comprising acts for accomplishing the particular result, as shown in FIG. 9. In one or more embodiments, FIG. 9 is performed with more or fewer acts. Further, in some embodiments, the acts are performed in different orders. Additionally, in some cases, the acts described herein are repeated or performed in parallel with one another or in parallel with different instances of the same or similar acts.

FIG. 9 illustrates a flowchart of a series of acts 900 for generating refined matte predictions for objects portrayed in a digital image in accordance with one or more embodiments. FIG. 9 illustrates acts according to one embodiment, but alternative embodiments omit, add to, reorder, and/or modify any of the acts shown in FIG. 9. In some implementations, the acts of FIG. 9 are performed as part of a computer-implemented method. Alternatively, in some embodiments, a non-transitory computer-readable medium stores instructions thereon that, when executed by at least one processor, cause the at least one processor to perform operations comprising the acts of FIG. 9. In some embodiments, a system performs the acts of FIG. 9. For example, in some cases, a system includes one or more memory devices. The system further includes one or more processors coupled to the one or more memory devices that cause the system to perform operations comprising the acts of FIG. 9.

The series of acts 900 includes an act 902 for receiving a digital image portraying one or more objects. For example, in one or more embodiments, the instance matting system 106 operates on a server device, and the act 902 involves receiving the digital image from a client device. In some embodiments, the instance matting system 106 operates on a client device and the act 902 involves receiving the digital image from local memory or from another system operating on the client device.

The series of acts 900 also includes an act 904 for generating a coarse matte prediction for each object using an instance matting neural network. For instance, in some cases, the act 904 involves generating, via an instance matting neural network and using the digital image and a guidance mask for each object from the one or more objects, a coarse matte prediction for each object. In some embodiments, generating, via the instance matting neural network, the coarse matte prediction for each object comprises generating, using one or more stacked cross-attention layers and one or more self-attention layers of the instance matting neural network, the coarse matte prediction for each object.

In one or more embodiments, the instance matting system 106 further extracts, using a pyramid feature extractor of the instance matting neural network, a set of features from the digital image and the guidance mask for each object. As such, in some cases, generating, using the digital image and the guidance mask for each object, the coarse matte prediction for each object comprises generating, using a subset of features from the set of features, the coarse matte prediction for each object.

Additionally, the series of acts 900 includes an act 906 for generating a refined matte prediction from the coarse matte prediction using an instance guidance model. To illustrate, in certain embodiments, the act 906 involves generating, using an instance guidance model of the instance matting neural network, a refined matte prediction for each object from the coarse matte prediction for each object. In some cases, generating the refined matte prediction for each object from the coarse matte prediction for each object comprises generating the refined matte prediction for each object using the coarse matte prediction for each object and one or more additional subsets of features from the set of features. For instance, in some cases, generating the refined matte prediction for each object using the coarse matte prediction for each object and the one or more additional subsets of features comprises generating the refined matte prediction for each object using the coarse matte prediction for each object, the one or more additional subsets of features, and one or more sparse convolution operations.

Indeed, in one or more embodiments, generating, using the instance guidance model, the refined matte prediction for each object from the coarse matte prediction for each object comprises generating the refined matte prediction for each object from the coarse matte prediction for each object using the instance guidance model implementing one or more sparse convolution operations. In some embodiments, the instance matting system 106 determines a set of dense features for the digital image and generates a set of sparse features for the digital image from the set of dense features. As such, in some cases, generating, using the instance guidance model, the refined matte prediction for each object from the coarse matte prediction from each object comprises generating, using the instance guidance model, the refined matte prediction for each object from the set of sparse features and the coarse matte prediction for each object.

In certain implementations, receiving the digital image portraying the one or more objects comprises receiving a video frame from a digital video; and generating, using the instance guidance model, the refined matte prediction for each object comprises generating, using the instance guidance model and for the video frame, a set of refined matte predictions having the refined matte prediction for each object.

In some embodiments, the instance matting system 106 further generates, using the instance guidance model and for a preceding video frame, a first additional set of refined matte predictions having a first additional refined matte prediction for each object from the one or more objects portrayed in the video frame; and generates, using the instance guidance model and for a subsequent video frame, a second additional set of refined matte predictions having a second additional refined matte prediction for each object from the one or more objects portrayed in the video frame. In some cases, the instance matting system 106 further generates a set of video frame mattes for the video frame by using the instance matting neural network to fuse the set of refined matte predictions for the video frame with the first additional set of refined matte predictions for the preceding video frame and the second additional set of refined matte predictions for the subsequent video frame.

The series of acts 900 further includes an act 908 for providing a modified digital image generated from the refined matte prediction for display. For example, in some instances, the act 908 involves providing, for display, a modified digital image generated from the refined matte prediction for each object. To illustrate, in some cases, the instance matting system 106 provides the modified digital image for display on a graphical user interface of the client device from which the digital image was received. In some cases, the instance matting system 106 also performs the modification of the digital image using the refined matted prediction(s).

In one or more embodiments, providing the modified digital image generated from the refined matte prediction for each object comprises providing a modified video frame generated from a set of video frame mattes for the video frame.

To provide an illustration, in one or more embodiments, the instance matting system 106 extracts, from a video frame that portrays a plurality of objects and a set of guidance masks having a binary mask for each object, a set of features for the video frame via an instance matting neural network; generates a set of coarse matte predictions for the video frame by using the instance matting neural network to fuse the set of features for the video frame with an additional set of features for at least one adjacent video frame; determines, using an instance guidance model of the instance matting neural network, a set of refined matte predictions for the video frame from the set of coarse matte predictions; and generates a set of video frame mattes for the video frame by using the instance matting neural network to fuse the set of refined matte predictions for the video frame with an additional set of refined matte predictions for the at least one adjacent video frame.

In some embodiments, fusing, using the instance matting neural network, the set of features for the video frame with the additional set of features for the at least one adjacent video frame comprises fusing, using the instance matting neural network, the set of features for the video frame with a first additional set of features for a preceding video frame and a second additional set of features for a subsequent video frame. In some instances, fusing, using the instance matting neural network, the set of refined matte predictions for the video frame with the additional set of refined matte predictions for the at least one adjacent video frame comprises fusing, using the instance matting neural network, the set of refined matte predictions for the video frame with a first additional set of refined matte predictions for the preceding video frame and a second additional set of refined matte predictions for the subsequent video frame.

In some implementations, extracting, from the video frame and the set of guidance masks, the set of features for the video frame via the instance matting neural network comprises extracting, from the video frame and the set of guidance masks via a pyramid feature extractor of the instance matting neural network, the set of features having a plurality of subsets of features at different scales. In some instances, generating the set of coarse matte predictions for the video frame by using the instance matting neural network to fuse the set of features for the video frame with the additional set of features for the at least one adjacent video frame comprises generating the set of coarse matte predictions for the video frame by using the instance matting neural network to fuse a first subset of features from the plurality of subsets of features that corresponds to a first scale with the additional set of features for the at least one adjacent video frame. In some cases, the instance matting system 106 further generates a set of intermediate matte predictions for the video frame using at least a second subset of features from the plurality of subsets of features that corresponds to a second scale; and determining the set of refined matte predictions for the video frame from the set of coarse matte predictions comprises determining the set of refined matte predictions for the video frame from the set of coarse matte predictions and the set of intermediate matte predictions. Additionally, in certain embodiments, the instance matting system 106 further modifies the video frame using the set of video frame mattes.

To provide another illustration, in one or more embodiments, the instance matting system 106 receives a digital image portraying one or more objects; generates, via an instance matting neural network and using the digital image and a guidance mask corresponding to each object from the one or more objects, a coarse matte prediction for each object; generates, using an instance guidance model of the instance matting neural network, a refined matte prediction from the coarse matte prediction; and provides, for display, a modified digital image generated via the refined matte prediction.

In some embodiments, generating, using the instance guidance model of the instance matting neural network, the refined matte prediction from the coarse matte prediction comprises: generating, using the instance guidance model, a plurality of intermediate matte predictions for each object from the digital image and the guidance mask corresponding to each object; and generating the refined matte prediction by fusing the coarse matte prediction for each object with the plurality of intermediate matte predictions. In some cases, generating the plurality of intermediate matte predictions comprises: generating, for each object, a first intermediate matte prediction having a first scale that differs from a scale of the coarse matte prediction for each object; and generating, for each object, a second intermediate matte prediction having a second scale that differs from the first scale and the scale of the coarse matte prediction for each object.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that is configured to perform one or more of the processes described above in some embodiments. One will appreciate that one or more computing devices, such as the computing device 1000, represent the computing devices described above (e.g., the server device(s) 102 and/or the client devices 110a-110n) in some implementations. In one or more embodiments, the computing device 1000 is a mobile device (e.g., a mobile telephone, a smartphone, a PDA, a tablet, a laptop, a camera, a tracker, a watch, a wearable device). In some embodiments, the computing device 1000 is a non-mobile device (e.g., a desktop computer or another type of client device). Further, in certain embodiments, the computing device 1000 is a server device that includes cloud-based processing and storage capabilities.

As shown in FIG. 10, the computing device 1000 includes one or more processor(s) 1002, memory 1004, a storage device 1006, input/output interfaces 1008 (or “I/O interfaces 1008”), and a communication interface 1010, which are communicatively coupled by way of a communication infrastructure (e.g., bus 1012). While the computing device 1000 is shown in FIG. 10, the components illustrated in FIG. 10 are not intended to be limiting. Additional or alternative components are used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 retrieve (or fetch) the instructions from an internal register, an internal cache, memory 1004, or a storage device 1006 and decode and execute them in some implementations.

The computing device 1000 includes memory 1004, which is coupled to the processor(s) 1002. In certain cases, the memory 1004 is used for storing data, metadata, and programs for execution by the processor(s). In some instances, the memory 1004 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 1004 includes internal or distributed memory.

The computing device 1000 includes a storage device 1006 including storage for storing data or instructions. As an example, and not by way of limitation, in some cases, the storage device 1006 includes a non-transitory storage medium described above. In some embodiments, the storage device 1006 includes a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. In one or more embodiments, these I/O interfaces 1008 include a mouse, keypad or a keyboard, a touch screen, camera, optical scanner, network interface, modem, other known I/O devices or a combination of such I/O interfaces 1008. In some cases, the touch screen is activated with a stylus or a finger.

In one or more embodiments, the I/O interfaces 1008 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. In some cases, the graphical data is representative of one or more graphical user interfaces and/or any other graphical content that serves a particular implementation.

The computing device 1000 further includes a communication interface 1010. In some cases, the communication interface 1010 includes hardware, software, or both. The communication interface 1010 provides one or more interfaces for communication (such as, for example, packet-based communication) between the computing device and one or more other computing devices or one or more networks. As an example, and not by way of limitation, in some cases, communication interface 1010 includes a network interface controller (NIC) or network adapter for communicating with an Ethernet or other wire-based network or a wireless NIC (WNIC) or wireless adapter for communicating with a wireless network, such as a WI-FI. The computing device 1000 further includes a bus 1012. In some cases, the bus 1012 includes hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a digital image portraying one or more objects;
generating, via an instance matting neural network and using the digital image and a guidance mask for each object from the one or more objects, a coarse matte prediction for each object;
generating, using an instance guidance model of the instance matting neural network, a refined matte prediction for each object from the coarse matte prediction for each object; and
providing, for display, a modified digital image generated from the refined matte prediction for each object.

2. The computer-implemented method of claim 1, wherein generating, using the instance guidance model, the refined matte prediction for each object from the coarse matte prediction for each object comprises generating the refined matte prediction for each object from the coarse matte prediction for each object using the instance guidance model implementing one or more sparse convolution operations.

3. The computer-implemented method of claim 1, wherein generating, via the instance matting neural network, the coarse matte prediction for each object comprises generating, using one or more stacked cross-attention layers and one or more self-attention layers of the instance matting neural network, the coarse matte prediction for each object.

4. The computer-implemented method of claim 1, further comprising:
determining a set of dense features for the digital image; and
generating a set of sparse features for the digital image from the set of dense features,
wherein generating, using the instance guidance model, the refined matte prediction for each object from the coarse matte prediction from each object comprises generating, using the instance guidance model, the refined matte prediction for each object from the set of sparse features and the coarse matte prediction for each object.

5. The computer-implemented method of claim 1, wherein:
receiving the digital image portraying the one or more objects comprises receiving a video frame from a digital video; and
generating, using the instance guidance model, the refined matte prediction for each object comprises generating, using the instance guidance model and for the video frame, a set of refined matte predictions having the refined matte prediction for each object.

6. The computer-implemented method of claim 5, further comprising:
generating, using the instance guidance model and for a preceding video frame, a first additional set of refined matte predictions having a first additional refined matte prediction for each object from the one or more objects portrayed in the video frame; and
generating, using the instance guidance model and for a subsequent video frame, a second additional set of refined matte predictions having a second additional refined matte prediction for each object from the one or more objects portrayed in the video frame.

7. The computer-implemented method of claim 6,
further comprising generating a set of video frame mattes for the video frame by using the instance matting neural network to fuse the set of refined matte predictions for the video frame with the first additional set of refined matte predictions for the preceding video frame and the second additional set of refined matte predictions for the subsequent video frame,
wherein providing the modified digital image generated from the refined matte prediction for each object comprises providing a modified video frame generated from the set of video frame mattes for the video frame.

8. The computer-implemented method of claim 1,
further comprising extracting, using a pyramid feature extractor of the instance matting neural network, a set of features from the digital image and the guidance mask for each object,
wherein generating, using the digital image and the guidance mask for each object, the coarse matte prediction for each object comprises generating, using a subset of features from the set of features, the coarse matte prediction for each object.

9. The computer-implemented method of claim 8, wherein generating the refined matte prediction for each object from the coarse matte prediction for each object comprises generating the refined matte prediction for each object using the coarse matte prediction for each object and one or more additional subsets of features from the set of features.

10. The computer-implemented method of claim 9, wherein generating the refined matte prediction for each object using the coarse matte prediction for each object and the one or more additional subsets of features comprises generating the refined matte prediction for each object using the coarse matte prediction for each object, the one or more additional subsets of features, and one or more sparse convolution operations.

11. A system comprising:
one or more memory devices; and
one or more processors coupled to the one or more memory devices that cause the system to perform operations comprising:
extracting, from a video frame that portrays a plurality of objects and a set of guidance masks having a binary mask for each object, a set of features for the video frame via an instance matting neural network;
generating a set of coarse matte predictions for the video frame by using the instance matting neural network to fuse the set of features for the video frame with an additional set of features for at least one adjacent video frame;
determining, using an instance guidance model of the instance matting neural network, a set of refined matte predictions for the video frame from the set of coarse matte predictions; and
generating a set of video frame mattes for the video frame by using the instance matting neural network to fuse the set of refined matte predictions for the video frame with an additional set of refined matte predictions for the at least one adjacent video frame.

12. The system of claim 11, wherein fusing, using the instance matting neural network, the set of features for the video frame with the additional set of features for the at least one adjacent video frame comprises fusing, using the instance matting neural network, the set of features for the video frame with a first additional set of features for a preceding video frame and a second additional set of features for a subsequent video frame.

13. The system of claim 12, wherein fusing, using the instance matting neural network, the set of refined matte predictions for the video frame with the additional set of refined matte predictions for the at least one adjacent video frame comprises fusing, using the instance matting neural network, the set of refined matte predictions for the video frame with a first additional set of refined matte predictions for the preceding video frame and a second additional set of refined matte predictions for the subsequent video frame.

14. The system of claim 11, wherein extracting, from the video frame and the set of guidance masks, the set of features for the video frame via the instance matting neural network comprises extracting, from the video frame and the set of guidance masks via a pyramid feature extractor of the instance matting neural network, the set of features having a plurality of subsets of features at different scales.

15. The system of claim 14, wherein generating the set of coarse matte predictions for the video frame by using the instance matting neural network to fuse the set of features for the video frame with the additional set of features for the at least one adjacent video frame comprises generating the set of coarse matte predictions for the video frame by using the instance matting neural network to fuse a first subset of features from the plurality of subsets of features that corresponds to a first scale with the additional set of features for the at least one adjacent video frame.

16. The system of claim 15, wherein:
the operations further comprise generating a set of intermediate matte predictions for the video frame using at least a second subset of features from the plurality of subsets of features that corresponds to a second scale; and
determining the set of refined matte predictions for the video frame from the set of coarse matte predictions comprises determining the set of refined matte predictions for the video frame from the set of coarse matte predictions and the set of intermediate matte predictions.

17. The system of claim 16, wherein the operations further comprise modifying the video frame using the set of video frame mattes.

18. A non-transitory computer-readable medium storing instructions thereon that, when executed by at least one processor, cause the at least one processor to perform operations comprising:
receiving a digital image portraying one or more objects;
generating, via an instance matting neural network and using the digital image and a guidance mask corresponding to each object from the one or more objects, a coarse matte prediction for each object;
generating, using an instance guidance model of the instance matting neural network, a refined matte prediction from the coarse matte prediction; and
providing, for display, a modified digital image generated via the refined matte prediction.

19. The non-transitory computer-readable medium of claim 18, wherein generating, using the instance guidance model of the instance matting neural network, the refined matte prediction from the coarse matte prediction comprises:
generating, using the instance guidance model, a plurality of intermediate matte predictions for each object from the digital image and the guidance mask corresponding to each object; and
generating the refined matte prediction by fusing the coarse matte prediction for each object with the plurality of intermediate matte predictions.

20. The non-transitory computer-readable medium of claim 19, wherein generating the plurality of intermediate matte predictions comprises:
generating, for each object, a first intermediate matte prediction having a first scale that differs from a scale of the coarse matte prediction for each object; and
generating, for each object, a second intermediate matte prediction having a second scale that differs from the first scale and the scale of the coarse matte prediction for each object.
